(19) United States
(12) Patent Application Publication
(10) Pub. No.: US 2017/0229897 A1
(43) Pub. Date: Aug. 10, 2017

(54) DEVICES AND METHODS FOR PORTABLE ENERGY STORAGE

(71) Applicant: DTA Products Inc., Morgan Hill, CA (US)

(72) Inventor: Ahmad Rick Ashrafzadeh, Morgan Hill, CA (US)

(73) Assignee: DTA Products Inc., Morgan Hill, CA (US)

(21) Appl. No.: 15/426,360

(22) Filed: Feb. 7, 2017

Related U.S. Application Data
(60) Provisional application No. 62/293,179, filed on Feb. 9, 2016.

(51) Int. Cl. H02J 7/02; H02J 7/00

(52) U.S. Cl. CPC H02J 7/022; H02J 7/0013; H02J 7/0065; H02J 7/007; H02J 7/0052; H02J 2007/0059

(57) ABSTRACT

Disclosed are portable energy storage devices and methods for fast charging them using non-isolated power supplies, while maintaining device and user safety. Techniques are disclosed to reduce the size of power supplies needed to charge portable energy storage devices and reduce the charge time of these devices.

### CROSS-REFERENCE TO RELATED APPLICATIONS

This application claims the benefit of priority under 35 U.S.C. §119(e) of U.S. Provisional Application No. 62/293,179 filed on Feb. 9, 2016 entitled “Fast Charging Battery Pack with Non-Isolated Power supply,” content of which is incorporated herein by reference in its entirety and should be considered a part of this specification.

### BACKGROUND

Field of the Invention

This invention relates generally to power banks enclosing battery packs capable of powering electronic devices, and more particularly, to methods and devices for fast charging of battery packs.

Description of the Related Art

Electronic devices powered by secondary batteries are used more frequently and for longer durations leading to frequent need for recharging those secondary batteries. Portable power banks exist to allow users to charge secondary batteries of their electronic devices when a wall outlet might not be available or may be inconvenient to access. Current portable power banks can take a long time to recharge, diminishing the convenience that the portable power bank can provide. In some cases, existing power banks can take up to or more than 8 hours to be fully recharged. Additionally, many conventional power banks require carrying an external AC/DC or other power supply or battery charger (for example, in the form factor of a brick charger) to provide suitable current or voltage for charging those power banks. The addition of an external power supply or charger also diminishes the convenience and portability of those power banks.

### SUMMARY

One embodiment includes a device, where the device includes: an AC input terminal and a DC output terminal; a battery pack; a power supply and battery charger operatively coupled to the AC input terminal and configured to convert electrical energy to a form suitable for charging the battery pack; a DC/DC converter operatively coupled to the battery pack and the DC output terminal and configured to convert a voltage of the battery pack to a constant voltage and output the constant voltage to the DC output terminal; and a housing which includes the AC input terminal, the DC output terminal, the battery pack, the power supply, the battery charger and the dc/dc converter, wherein the AC input terminal and the DC output terminal are arranged on a surface of the housing such that when the AC input terminal is externally connected, the DC output terminal is blocked and when the DC output terminal is externally connected, the AC input terminal is blocked.

In one aspect, the battery pack further includes a series arrangement of battery cells.

In one aspect, the power supply includes a non-isolated power supply.

In one aspect, the non-isolated power supply can include: a buck converter, tapped buck converter, tapped inductor buck converter, a forward converter, a two-switch forward converter, a resonant converter, a push-pull converter, a half-bridge converter, a full bridge converter, a phase-shifted full bridge converter, a fly-bank converter, a SEPIC converter, a buck-boost converter or a auk converter.

In another aspect, the AC terminal can include prongs and the DC terminal is placed in between the prongs.

In one aspect, the prongs pivotally move and stow away in a channel of the housing.

In one aspect, the device further includes a DC terminal cover slidably movable to expose or cover the DC output terminal, wherein when the DC output terminal is exposed, the AC input terminal is stowed away and when the DC output terminal is covered, the AC input terminal is extended and available for external electrical connection.

In another aspect, the device further includes a DC input terminal operatively coupled to the battery charger.

In one aspect, the device further includes a display module indicative of one or more status parameters of the battery pack.

In another aspect, the power supply and battery charger are integrated.

In one aspect, the device further includes a control circuit configured to generate a charger control signal, wherein the charger control signal is a high value for input voltages above a threshold voltage and the charger control signal is a low value for input voltages below the threshold value and the battery charger is cycled between on and off states in part based on the charger control signal.

In one aspect, the control circuit is a comparator.

In another aspect, the DC/DC converter further includes isolation circuitry, such that a direct connection through an electrical connector between the AC input terminal and the DC output terminal is eliminated.

Another embodiment includes a method, where the method includes: arranging an AC input terminal and a DC output terminal on a power bank housing such that when the AC input terminal is externally connected, the DC output terminal is blocked and when the DC output terminal is externally connected, the AC input terminal is blocked; receiving a sine-wave input voltage at the AC input terminal; converting the sine-wave input voltage to a half sine-wave voltage; driving a battery charger with the half sine-wave; generating a charger control signal, wherein the charger control signal is a high value for half sine-wave voltage values above a threshold voltage and the charger control signal is a low value for half sine-wave voltage values below the threshold voltage; cycling the battery charger between on and off states in part based on the charger control signal; and charging a battery pack with the battery charger.

In one aspect, the battery pack includes a series arrangement of battery cells.

In one aspect, charging the battery pack includes providing a voltage where the voltage is a sum of voltages of the battery cells and a low current to the battery cells.

In one aspect, the method further includes providing a DC terminal cover slidably movable to expose or cover the DC output terminal, wherein when the DC output terminal is exposed, the AC input terminal is stowed away and when the DC output terminal is covered, the AC input terminal is extended and available for external electrical connection.

Another embodiment includes a device, where the device includes means for receiving an AC input and means for delivering a DC output such that when the means for AC input is externally connected, the means for DC output is blocked and when the means for DC output is externally connected, the means for AC input is blocked; means for receiving a sine-wave input voltage; means for converting the sine-wave input voltage to a half sine-wave voltage; means for charging a battery pack with the half sine-wave; means for generating a charger control signal, wherein the charger control signal is a high value for half sine-wave voltage values above a threshold voltage and the charger control signal is a low value for half sine-wave voltage values below the threshold voltage; and means for cycling the means for charging between on and off states in part based on the charger control signal.

In one aspect, the battery pack includes a series arrangement of battery cells.

In another aspect, the means for receiving the AC input is capable of stowing away.

### BRIEF DESCRIPTION OF THE DRAWINGS

These drawings and the associated description herein are provided to illustrate specific embodiments of the invention and are not intended to be limiting.

FIG. 1 illustrates an example of an application where an embodiment of the invention may advantageously be used to improve efficiency and portability.

FIG. 2 is a diagram of a portable energy storage system according to an embodiment.

FIGS. 3A-3D illustrate example implementations of the portable energy storage system of FIG. 2.

FIG. 4 illustrates example charging power signal and control signal, which can be used with the embodiments of the invention.

FIG. 5 illustrates an example power supply according to an embodiment.

FIG. 6 illustrates an example battery charger, which can be used with the embodiment of FIG. 5.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

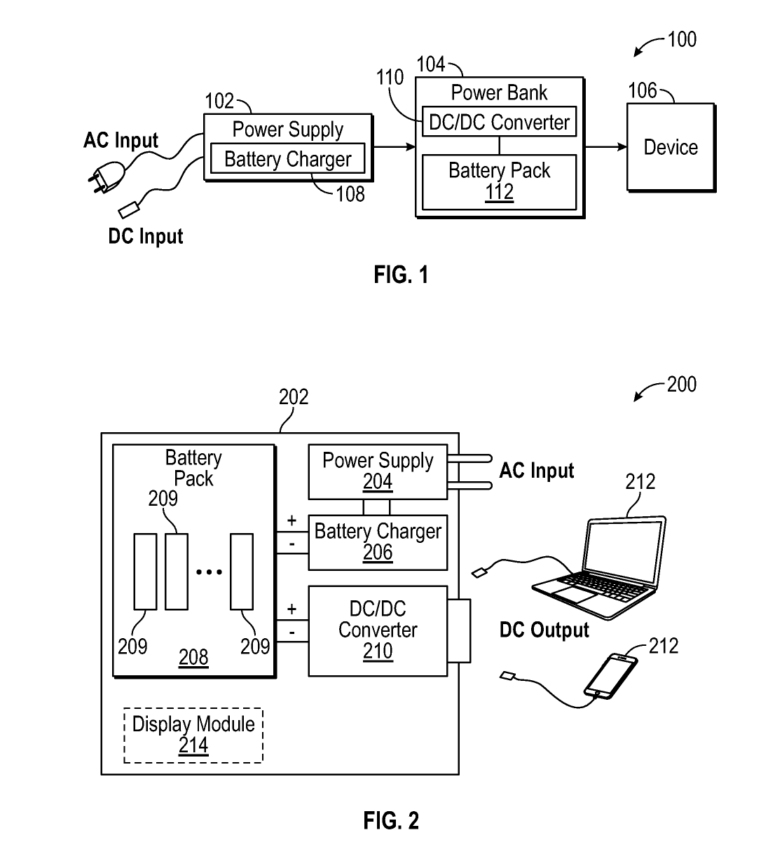

FIG. 1 is a diagram of a system 100 for providing portable energy storage. The power supply 102 can charge a portable power bank 104. The portable power bank 104 can power the electronic device 106. The electronic device 106 can include a secondary battery, which can be recharged by drawing energy from the portable power bank 104. An example application of the system 100 can include, for example, a user charging the power bank 104 using the power supply 102. The user can disconnect the power bank 104 from the power supply 102. When the power bank 104 is charged, the user can disconnect the power bank 104 from the power supply 102 and carry the power bank 104 to power the user's electronic devices, for example, while travelling and in circumstances where access to an electrical outlet may be limited or inconvenient.

The electronic device 106 can include smart phones, laptops or other portable or non-portable devices whose operations require electrical energy. The power supply 102 can include devices and associated circuitry for converting electrical energy to a form suitable for charging the power bank 104. Power supply 102 can include devices or circuitry for converting alternating input current or voltage to direct current or voltage, for example via an AC/DC converter. The power supply 102 can be devices or circuitry for converting direct input current or voltage of one value to direct current or voltage of another value, for example via a DC/DC converter. In some cases, the DC input of a power supply 102 can be a Universal Serial Bus (USB) connection. The power bank 104 can include a battery pack 112 consisting of electro-chemical components for energy storage. The power bank 104 can additionally include electrical components for battery pack management or cell balancing. Additionally, the power bank 104 can include a DC/DC converter 110 to convert the variable voltage of the battery pack to a constant output voltage suitable for charging the electrical device 106. As described, the electrical device 106 can include any portable or non-portable device, which can draw and use electrical energy from the battery pack 104.

The power supply 102 can have a terminal for connecting to a wall outlet. An internal AC/DC converter and associated circuitry can turn the electrical energy drawn from an electrical wall outlet to electrical energy suitable for charging the power bank 104. The conversion can include modifying voltages, currents or electrical power from one value to another in order to provide a suitable charging current or voltage for the battery pack 112. Additionally, the power supply 102 can include a battery charger 108 to manage the charging of the power bank 104. For example, some battery chargers control the current, voltage, power, timing and duration under which the power bank 104 may be optimally or near optimally recharged.

The system 100 typically uses an isolated power supply to implement the power supply 102 for safety reasons. An isolated power supply can be designed to eliminate any direct electrical connection or pathway between a human user and a potentially unsafe high voltage or current source of electrical energy. Electrical isolation can be achieved by using transformers and other circuitry in the design of power supply 102, such that no physical path or electrical connection exists between the energy source (for example an electrical wall outlet) and a human user. However, electrical isolation adds to the complexity of the power supply 102, its cost of manufacture and reduces the efficiency and speed by which power supply 102 can recharge power bank 104. Additionally, the complexities associated with the design of an isolated power supply generally means that power supply 102 can be physically several times larger and heavier than battery pack 104, thereby reducing the portability and convenience of the system 100. Although, smaller and more compact isolated power supplies exist, the smaller form factor comes at the expense of making the power supply weak and inefficient leading to long charge times when these power supplies are used.

FIG. 2 is a diagram of a portable energy storage system 200 according to an embodiment. The power bank 202 can include a power supply 204, battery charger 206, battery pack 208 and a DC/DC converter 210. The power supply 204 can include an AC/DC converter which accepts an AC input (for example, from an electrical wall outlet) to provide a current source or voltage source for the battery charger 206. The battery charger 206 can be chosen based on the parameters and specifications of the battery pack 208. The battery charger 206 can include circuitry to control voltage, current, power, timing, duration and other parameters, to optimally or near-optimally charge or recharge the battery pack 208. DC/DC converter 210 can convert the battery pack 208 voltage to a fixed or near-fixed DC voltage usable by electronic devices 212. In some embodiments, the output of the DC/DC converter 210 can be via a Universal Serial Bus (USB) output. The functions and algorithms of the power supply 204 and battery charger 206 can be performed by separate circuits or can be combined into a single component. The DC/DC converter 210 can optionally include features such as protection against over-current and over-temperature.

In some embodiments, the power bank 202 can optionally include a display module 214 to provide a visual of the status of the power bank 202 to its user. Persons of ordinary skill in the art can envision various designs for the Display module 214. For example, a row of LED lights can be used and lit up depending on the status of charge of the battery pack 208. Alternatively or in addition, an LCD or other displays capable of conveying text or other information about the status of the power bank 202 can be implemented.

Advantageously, the power supply 204 can be a non-isolated power supply, allowing for a smaller form factor and integration into the power bank 202. Non-isolated power supplies enjoy advantages over the isolated power supplies. Non-isolated power supplies can be designed with less complexity and are cheaper to manufacture. They can provide more efficient charging parameters and can charge the battery pack 208 in less time than may be achieved by using an isolated power supply. Additionally, non-isolated power supplies can be designed to be much lighter and physically smaller than their isolated counterparts. Consequently, unlike the power bank 104, which uses an external isolated power supply 102, the non-isolated power supply 204 can be integrated into the power bank 202 in a form factor that retains portability and convenience of the power bank 202. Using the integrated non-isolated power supply 204 relieves a user of the power bank 202 from having to carry an external power supply. While power banks with integrated power supplies exist, these power banks take a considerably long time for recharging, due to the inefficiency associated with having to use compact isolated power supplies. As described earlier, compact, isolated power supplies are typically weaker and provide low charging currents leading to longer charge times when such compact, isolated power supplies are integrated in a power bank.

Efficient charging of a battery pack can be achieved by monitoring and controlling various parameters including the voltage, current and power delivered to the battery pack as well as duration, timing and frequency in relation to the voltage, current, temperature and other battery pack parameters during a charging session. Often, sensing output parameters are a part of an efficient charging technique. In the case of isolated power supplies, typically sensing the charging parameters, for example, the output voltage and current, through the isolation circuitry can be slow, unreliable, inaccurate and expensive to implement. Consequently, many such power supplies have limited feedback of the charging or battery pack parameters, making them unreliable or inefficient. By contrast, a non-isolated power supply can have direct sensing and feedback on charging and battery pack parameters, making it more reliable and efficient compared to isolated power supplies.

Examples of non-isolated topologies can include buck converters and its variations, flyback with primary and secondary ground shorted and variations of flyback topology. In such examples, the Pulse Width Modulation (PWM) circuitry of the power supply can have direct connection to the power supply output for sensing voltages and currents, making the power supply simpler, more robust, and lower the cost of manufacturing the power supply. Variations of the buck converter topology, which can be used include but are not limited to tapped inductor buck, forward, two-switch forward, resonant converter, push-pull, half bridge, full bridge and phase-shifted full-bridge. Variations of flyback topology which can be used include, but are not limited to, single-ended primary-inductor converter (SEPIC), buck-boost and auk converter. Persons of ordinary skill in the art can envision other non-isolated power supply topologies for use with the embodiments and examples described herein.

The battery pack 208 can include one or more electro-chemical battery cells 209 or other battery cells using various technologies. Conventional battery packs place the battery cells in parallel for a number of reasons including ease of design, and the need to utilize existing battery chargers. These conventional battery packs in many cases use USB chargers to charge the battery cells. Typically, the charging voltage using a USB charger can be limited to around 5 Volts (V). Individual battery cell voltages may be about 4V. Putting the battery cells in parallel enables charging of multiple battery cells without needing voltages beyond 4-5V provided by existing USB chargers. A disadvantage of placing the battery cells in parallel and charging them with relatively low 4-5V charging voltage is that the charging times for these battery packs can be several hours long. This reduces the convenience and in some cases usefulness of a portable battery pack.

In some aspects, the battery pack 208 can be configured with battery cells arranged in series. Advantageously, the power supply 204 and battery charger 206 can be designed and integrated in the power bank 202 in a manner suitable for fast and efficient charging of the series arrangement of the battery cells. Unlike the case where the battery cells are in parallel, the power supply 204 and battery charger 206 can be configured to provide a relatively high voltage and relatively low current for charging the cells of the battery pack 208. As a non-limiting example, when 4 battery cells of approximately 4V are used, the power supply 204 and the battery charger 206 can be configured to provide a charging voltage of 16V, a voltage, which a standard USB charger may not be able to provide. An advantage of being able to provide a relatively high charging voltage is that the battery pack 208 can be charged faster compared to conventional low voltage charging schemes. For example, a 30 Watt Hour battery can be charged in approximately 45 minutes, using the embodiments described herein, while the charging time for the same battery using conventional methods and devices can exceed 8 hours.

Additionally, a relatively high charging voltage can allow a relatively low charging current. In the context of charging batteries, high currents can be problematic because they generate heat and waste energy in the power supply. When a series arrangement of battery cells is used, the total power delivered to the battery cells in a given charging session can be kept high, by using a relatively high voltage, while at the same time maintaining a relatively low charging current. For example, in a 4-cell battery pack, having a parallel arrangement of battery cells, a 5V USB charger and a 2 amps (A) charging current can deliver a total of 10 Watts (W) power to the battery pack. On the other hand, if the same 4 cells are arranged in series, and charged with the same 2 A charging current, if the voltage of each battery cell is 4V, a total of 32W power can be delivered to the battery pack, dramatically reducing the charge time.

Additionally, in isolated power supplies, the size of the magnetic elements, for example, the transformers, is related to the output power. This is not the case for a non-isolated power supply. The size of magnetic elements in a non-isolated power supply, such as a buck regulator, is related to the output current. With this in mind, by increasing the output voltage of such a power supply, one can increase the output power without having to increase the size of the power supply. This helps provide larger output power using a non-isolated power supply when charging series batteries, while keeping the power supply size small.

Some battery packs utilize lithium-ion battery cells, a DC/DC power supply and a charger. The charger can be a trickle charger, a high current switching charger or other kinds. The charge time usually depends on the battery pack capacity and its charge rate. The charge rate can be defined as what a safe charge current might be based on the specifications provided by a battery manufacturer. The charge time can also depend on the battery capacity, battery charge rate, charger capability, supply current and other factors. A typical 2 ampere hour (AH) battery with a 1C charge rate can require 2 A per hour to charge. With a typical USB charger providing approximately 500 mA charging current, and considering various efficiency losses, a total charge time of more than one hour may be needed to charge a typical battery. Additionally, the charging efficiency of linear chargers can also be further hampered by heat dissipation, and as with USB chargers, charging currents in the order of 500 mA or less can be typical to reduce heat dissipation. Additionally, in many cases, the typical USB chargers are capable of delivering a maximum voltage of approximately 5V. Consequently, the power (product of voltage and current) available to deliver to a battery pack for charging can be relatively low when a low voltage USB charger is utilized to charge the battery pack. The charge time for these battery packs can exceed multiple hours. Similarly, many isolated power supplies deliver charging currents much less than 2 A, at relatively low voltages, requiring charge times of more than few hours.

In summary, the combination of factors, as discussed above, cause the parallel cell battery packs, which use USB chargers or isolated power supplies to require charge times of several hours. The relatively low voltage, low current power supplies and chargers used for charging these battery packs work with battery cells arranged in parallel. By contrast, the disclosed portable energy storage systems, can utilize a series arrangement of battery cells and non-isolated power supplies configured to deliver high electrical power, by delivering a high voltage, while maintaining a relatively low current to reduce or minimize heat dissipation.

However, as described, conventional battery packs have not typically used non-isolated power supplies for safety reasons.

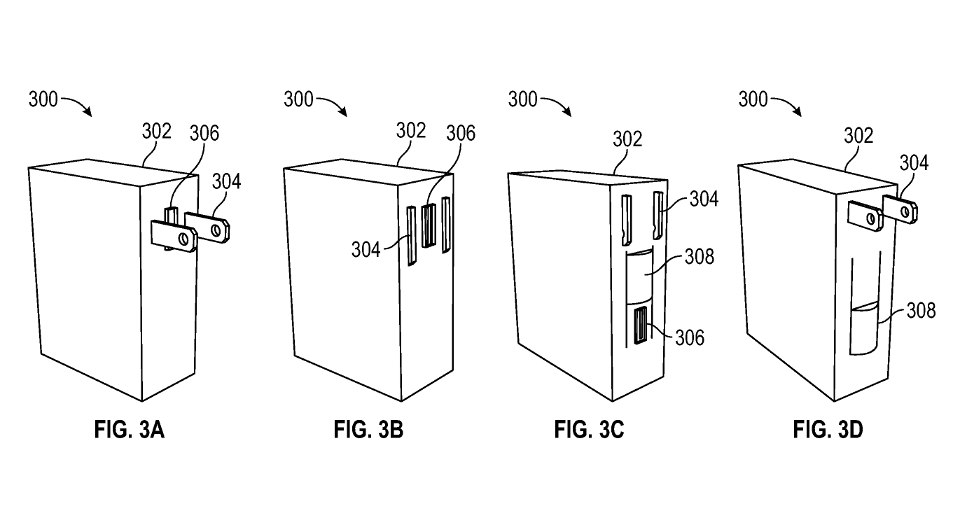

FIG. 3A illustrates an example power bank 300 where despite using a non-isolated power supply, safety concerns have been addressed. The power bank 300 is enclosed in a housing 302. The power bank 302 has an AC input terminal 304 and a DC output terminal 306. The AC terminal 304 can be a two-prong outlet terminal capable of connecting to an electrical wall outlet. Other configurations of the AC terminal 304 can also be used to enable international outlet compatibility for the power bank 300. The DC terminal 306 can be a USB connection. Various placements and configurations of the terminals 304 and 306 can be used to prevent the possibility of a user connecting both terminals simultaneously. Advantageously, the placement of the terminals 304 and 306 on housing 302 eliminates the possibility of simultaneous connection through both terminals. For example, when the power bank 300 is plugged into an electrical wall outlet using the terminal 306, a user of the power bank 300 cannot simultaneously connect an electrical device through the DC terminal 306 because the terminal would be blocked by the wall outlet. Additionally, when the DC terminal 306 is connected to an electrical device, the power bank 300 cannot be connected to an electrical wall outlet. Other components of the power bank 300 can be similar to the components and description given in reference to FIG. 2 and housed inside the housing 302.

In some embodiments, the AC terminal 304 can be mechanically retracted into a groove on a side surface of the housing 302 to create convenient access to the DC terminal 306. FIG. 3B illustrates the power bank 300 with the AC terminal 304 in retracted or stowed-away position. Persons with ordinary skill in the art can envision various configurations for retracting, stowing away or extending the AC terminal 304, which can open or block access to the DC terminal 306 by retracting, stowing away, folding or extending the AC terminal 306. In some embodiments, springs or mechanical locking mechanisms can be utilized such that a user pressing on a retracted AC terminal 304 can release the AC terminal 304 from a locked position and lock the AC terminal 304 in the extended configuration for plugging to an electrical wall outlet. In other embodiments, the AC terminal 304 may be configured to pivot around a hinge, such that the user can simply press and pivotally rotate the AC terminal 304 in a semi-circle motion into grooves or channels on one of the side surfaces of the housing 302 to provide convenient access to the DC terminal 306.

In the example power bank 300 shown in FIGS. 3A-3B, the DC terminal 306 has been placed in close proximity to the AC terminal 304 such that access to one blocks access to the other. For example, by placing the DC terminal 306 between or in the middle of the two prongs of the AC terminal 304, the user can only simultaneously access one of the terminals 304 or 306. Such configuration eliminates the possibility of a direct electrical connection path between a potentially unsafe high voltage or current source (for example, an electrical wall outlet) and the user. In such configuration, an efficient and small non-isolated power supply can safely be used to provide fast charge times for the power bank 300.

Alternatively, the DC terminal 306 can be placed elsewhere on the housing 302 and other techniques can be used to eliminate simultaneous access to both terminals. For example, FIG. 3C illustrates the power bank 300 utilizing a DC terminal cover 308 in an open position allowing access to the DC terminal 306. When the user has access to the DC terminal 306, the AC terminal 304 is in a retracted or stowed away position. DC terminal cover 308 can be configured to use an actuator or other mechanical or electrical means to extend the AC terminal 304 as the DC cover 308 is moved to cover the DC terminal 306. FIG. 3D illustrates the power bank 300 with AC terminal 304 in extended position while the DC terminal cover 308 has masked and blocked access to the DC terminal 306. Consequently, a direct electrical path between a user and a potentially unsafe high voltage or current source (for example, an electrical wall outlet) can be avoided, thereby allowing for safe usage of a non-isolated power supply as described above.

Conventional power banks, in many cases, charge their battery packs using a constant or near-constant current or voltage. When the power source is an AC power source (for example an electrical wall outlet), these power banks use chargers that convert the input from the AC power source to a DC current or voltage which they use to charge their battery packs. The conversion of an AC power signal to a DC power signal is conventionally achieved by using a rectifier stage followed by a filter, for example, a bulk capacitor. An input AC power signal can be in the form of a sinusoidal waveform, which the rectifier stage can turn into a half-sine waveform. A bulk capacitor following the rectifier stage can turn the half-sine waveform into a constant or near constant voltage signal. However, such conversion schemes come with disadvantages. The filter stage can be bulky. For example, a large capacitor is often used for the filter stage. The bulky filter stage can diminish the portability of a power bank. Additionally, the filter stage can adversely affect a power supply's power factor. The power factor is a measure of how well an electrical device uses the power delivered to it. One practical way to assess power factor in an electrical device is by observing how similar the input current waveform and output voltage waveform are. Devices with good power factor demonstrate substantially similar looking input current and output voltage waveforms. The filter stage negatively affects the power factor and is a design constraint. For example, when a large capacitor is used for the filter stage, the output current shows a large peak and inrush at the top of the rectified sine-wave, while the current can be near zero throughout the rest of the waveform. This results in poor power-factor.

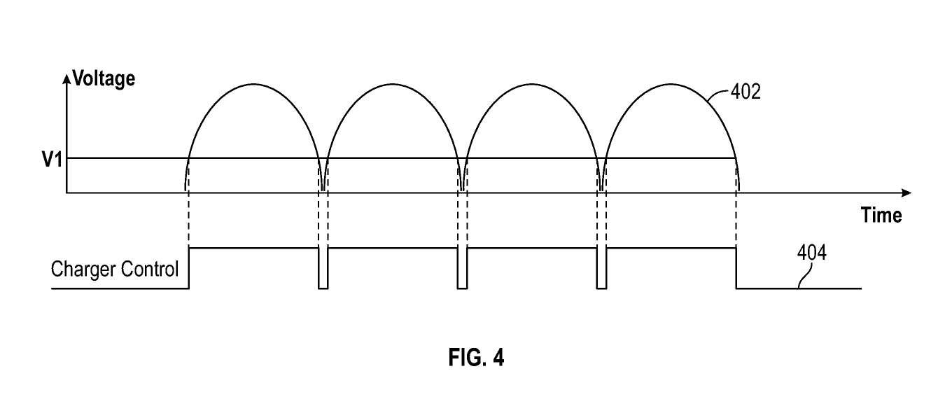

To achieve both a smaller-sized power supply and better power factor, the large bulk capacitor can be eliminated. Referring to FIG. 4, when the bulk capacitor is eliminated, the charging voltage waveform is similar to the graph 402. Despite not being a DC signal, the power signal 402 can be used to drive a battery charger circuit. For voltages above a threshold voltage V1, the power signal 402 can be applied to drive a battery charger. A charger control signal 404 can be utilized to turn the battery charger off for voltage values below the threshold voltage V1. The threshold voltage V1 can be determined based on the specifications and characteristics of the battery charger, the rectifier stage, the battery pack and other overall parameters of the energy storage system. In some embodiments, the charger control signal cycles the battery charger between on and off state 120 times a second at every half-sine wave interval.

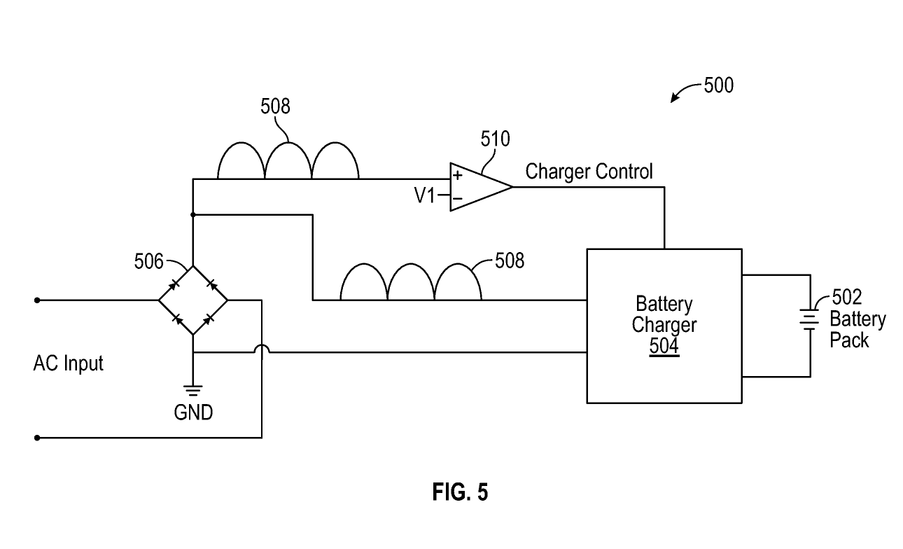

FIG. 5 illustrates an example power supply 500 where a large bulk capacitor has been eliminated. The power supply 500 can be used to charge the battery pack 502 via a battery charger 504. The AC input (for example from an electrical wall outlet) is rectified through a rectifier 506 generating a power signal 508. As shown, a diode bridge rectifier can be used to implement rectifier 506. Other rectifiers can also be used. The power signal 508 can be similar to the power signal 402 in waveform and characteristics as discussed above in relation to FIG. 4. The charger control signal can be generated by using a comparator 510. Comparator 510 can accept the rectified power signal 508 at its positive input and a reference threshold voltage V1 at its inverting input. The output of the comparator 510 is a charger control signal, which is a high/on voltage value when the power signal 508 is above the threshold voltage V1. The charger control signal is a low/off voltage value when the power signal 508 is below the threshold voltage V1. The charger control signal can switch the battery charger 504 on when the charger control is a high/on voltage value. The charger control signal can switch the battery charger 504 off when the charger control signal is a low/off value. This configuration allows the battery bank 502 to be pulse charged with the non-DC input waveform 508 and without requiring a large bulk capacitor.

Accordingly, the power supplies described herein can be designed smaller, by eliminating the bulk capacitor and can handle a wide range of input voltages. Isolated power supplies, on the other hand, use transformers, which can limit the range of input voltages these power supplies can handle.

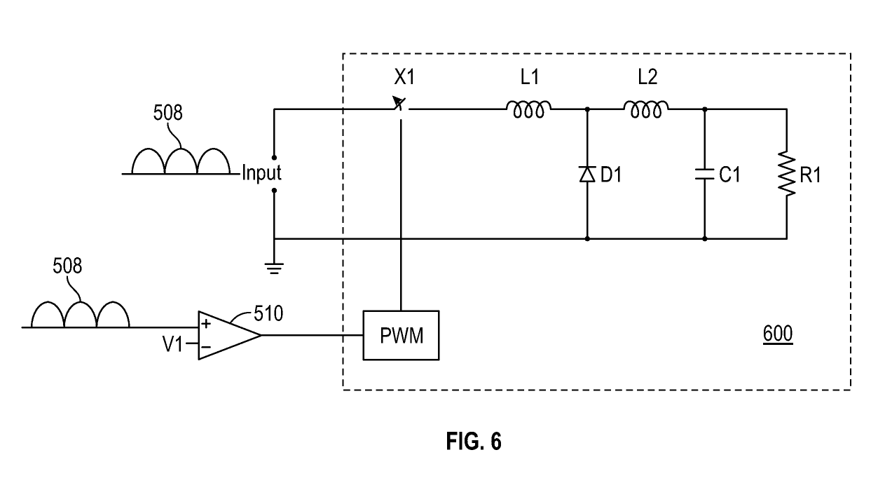

FIG. 6 illustrates an example battery charger 600, which can be used to implement the battery charger 504 of FIG. 5. The topology of battery charger 600 can be a tapped buck regulator or other isolated or non-isolated power supplies known to persons of ordinary skill in the art. The battery charger 600 can include inductors L1 and L2, diode D1, capacitor C1 and resistor R1 arranged as shown. Resistor R1 can be the battery pack 502. The switch X1 can be implemented using an NMOS transistor and controlled by a pulse width modulation (PWM) circuit. The transistor X1 can be driven by a power signal, for example, the power signal 508 as input. The charger control signal can introduce an additional control into the PWM circuit such that the PWM circuit, in addition to opening and closing the transistor X1 based on PWM functionality, also opens and closes the transistor X1 based on the charger control signal value, thereby cycling the charger 600 between on and off states. In some embodiments, the PWM cycles the transistor X1 between the open and closed state at the frequency of 200 KHz, while it also opens and closes the transistor X1 based on the charger control signal value at a frequency of 120 Hz.

The charger 504 is not limited to the topology shown for charger 600. As described earlier, other chargers can also be used. Variations of the buck converter topology, which can be used include but are not limited to, tapped inductor buck, forward, two-switch forward, resonant converter, push-pull, half bridge, full bridge and phase-shifted full-bridge. Variations of flyback topology which can be used include, but are not limited to, single-ended primary-inductor converter (SEPIC), buck- boost and auk converter. Persons of ordinary skill in the art can envision other power supply topologies for use with the embodiments and examples described herein.

In some embodiments, the isolation circuitry and function can still be included, but implemented in the DC/DC converter 210 as opposed to being included in the power supply 204. Compared to systems, which put the isolation function and circuitry in the power supply 204, putting the isolation in the DC/DC converter achieves the benefits of the isolation, without the typical design penalties associated with isolation as described above.

While the embodiments and techniques described herein are explained in the context of battery packs, their applications are not limited to those devices. Applications of the disclosed technology can extend to any device where efficient recharging of a secondary battery is desirable. Many electronic devices, toys or other electronics can benefit from the technology described herein.

What is claimed is:

1. A device comprising:
an AC input terminal and a DC output terminal;
a battery pack;
a power supply and battery charger operatively coupled to the AC input terminal and configured to convert electrical energy to a form suitable for charging the battery pack;
a DC/DC converter operatively coupled to the battery pack and the DC output terminal and configured to convert a voltage of the battery pack to a constant voltage and output the constant voltage to the DC output terminal; and
a housing comprising the AC input terminal, the DC output terminal, the battery pack, the power supply, the battery charger and the dc/dc converter, wherein the AC input terminal and the DC output terminal are arranged on a surface of the housing such that when the AC input terminal is externally connected, the DC output terminal is blocked and when the DC output terminal is externally connected, the AC input terminal is blocked.

2. The device of claim 1, wherein the battery pack comprises a series arrangement of battery cells.

3. The device of claim 1, wherein the power supply comprises a non-isolated power supply.

4. The device of claim 3, wherein the non-isolated power supply comprises a buck converter, tapped buck converter, tapped inductor buck converter, a forward converter, a two-switch forward converter, a resonant converter, a push-pull converter, a half-bridge converter, a full bridge converter, a phase-shifted full bridge converter, a fly-bank converter, a SEPIC converter, a buck-boost converter or a auk converter.

5. The device of claim 1, wherein the AC terminal comprises prongs and the DC terminal is placed in between the prongs.

6. The device of claim 5, wherein the prongs pivotally move and stow away in a channel of the housing.

7. The device of claim 1 further comprising a DC terminal cover slidably movable to expose or cover the DC output terminal, wherein when the DC output terminal is exposed, the AC input terminal is stowed away and when the DC output terminal is covered, the AC input terminal is extended and available for external electrical connection.

8. The device of claim 1 further comprising a DC input terminal operatively coupled to the battery charger.

9. The device of claim 1 further comprising a display module indicative of one or more status parameters of the battery pack.

10. The device of claim 1 wherein the power supply and battery charger are integrated.

11. The device of claim 1 further comprising a control circuit configured to generate a charger control signal, wherein the charger control signal is a high value for input voltages above a threshold voltage and the charger control signal is a low value for input voltages below the threshold voltage and the battery charger is cycled between on and off states in part based on the charger control signal.

12. The device of claim 11, wherein the control circuit is a comparator.

13. The device of claim 1, wherein the DC/DC converter further comprises isolation circuitry, such that a direct connection through an electrical connector between the AC input terminal and the DC output terminal is eliminated.

14. A method comprising:
arranging an AC input terminal and a DC output terminal on a power bank housing such that when the AC input terminal is externally connected, the DC output terminal is blocked and when the DC output terminal is externally connected, the AC input terminal is blocked;
receiving a sine-wave input voltage at the AC input terminal;
converting the sine-wave input voltage to a half sine-wave voltage;
driving a battery charger with the half sine-wave;
generating a charger control signal, wherein the charger control signal is a high value for half sine-wave voltage values above a threshold voltage and the charger control signal is a low value for half sine-wave voltage values below the threshold voltage;
cycling the battery charger between on and off states in part based on the charger control signal; and
charging a battery pack with the battery charger.

15. The method of claim 14, wherein the battery pack comprises a series arrangement of battery cells.

16. The method of claim 15, wherein charging the battery pack further comprises providing a voltage comprising a sum of voltages of the battery cells and a low current to the battery cells.

17. The method of claim 14 further comprising providing a DC terminal cover slidably movable to expose or cover the DC output terminal, wherein when the DC output terminal is exposed, the AC input terminal is stowed away and when the DC output terminal is covered, the AC input terminal is extended and available for external electrical connection.

18. A device comprising:
means for receiving an AC input and means for delivering a DC output such that when the means for AC input is externally connected, the means for DC output is blocked and when the means for DC output is externally connected, the means for AC input is blocked;
means for receiving a sine-wave input voltage;
means for converting the sine-wave input voltage to a half sine-wave voltage;
means for charging a battery pack with the half sine-wave;
means for generating a charger control signal, wherein the charger control signal is a high value for half sine-wave voltage values above a threshold voltage and the charger control signal is a low value for half sine-wave voltage values below the threshold voltage; and
means for cycling the means for charging between on and off states in part based on the charger control signal.

19. The device of claim 18, wherein the battery pack comprises a series arrangement of battery cells.

20. The device of claim 18 wherein the means for receiving the AC input is capable of stowing away.
